(19) United States
(12) Patent Application Publication
(10) Pub. No.: US 2022/0264725 A1
(43) Pub. Date: Aug. 18, 2022

(54) Dusk to Dawn Extension Cord Device

(71) Applicant: Fredrick Young, Abita Springs, LA (US)

(72) Inventor: Fredrick Young, Abita Springs, LA (US)

(21) Appl. No.: 17/671,857

(22) Filed: Feb. 15, 2022

Related U.S. Application Data
(60) Provisional application No. 63/150,297, filed on Feb. 17, 2021.

(51) Int. Cl. H05B 47/11; H05B 47/17; H05B 47/165

(52) U.S. Cl. CPC H05B 47/11; H05B 47/165; H05B 47/17

(57) ABSTRACT

The present invention relates to a multipurpose extension cord device that provides electrical power to electrically connected devices as a function of the level of environmental lighting. The device receives power from an external electric supply, and has one or more grounded outlets. At least one light sensor provides detected light levels to a microprocessor which compares the detected light levels with threshold light values stored in memory. Based on a comparison of detected light levels and threshold light values, the microprocessor signals a electric power cut-off module to enable or disable electric power to the outlets; thus automatically activating or deactivating the electrically connected devices based on changes in environmental light levels.

### CROSS-REFERENCE TO RELATED APPLICATION

The present application claims priority to, and the benefit of, U.S. Provisional Application No. 63/150,297, which was filed on Feb. 17, 2021, and is incorporated herein by reference in its entirety.

### FIELD OF THE INVENTION

The present invention relates generally to the field of extension cord devices. More specifically, the present invention relates to a novel extension cord that supplies electrical power to electronic devices as a function of the environmental light levels. The extension cord device receives electrical power by plugging into any standard electrical outlet and provides an output of electrical power through at least one grounded outlet to which electronic devices can be connected. At least one light sensor, a microprocessor and a cut-off circuit control the output of electrical power to the at least one grounded outlet. Accordingly, this disclosure makes specific reference thereto the present invention. Nonetheless, it is to be appreciated that aspects of the present invention are also equally applicable to other like applications, devices and methods of manufacture.

### BACKGROUND

By way of background, electrical extension cords are used ubiquitously in residential and commercial settings to provide temporary electrical power to electronic devices. All electronic devices consume electrical energy resulting in a corresponding energy bill. To reduce the size of the energy bill, it is desired that the electronic devices be on only when needed or desired.

Specifically, with respect to residential use, electrical extension cords are often used to supply electrical power to seasonal holiday lighting. The need for seasonal holiday lighting occurs between dusk and sunset, and dawn and sunrise; therefore, users need to manually plug in and unplug the extension cord to turn on the lighting at dusk and turn off the lighting at dawn. This process is time consuming and inconvenient. Users often forget to plug in or unplug the lights resulting in either loss of lighting in the former and unnecessarily large energy bills in the latter. These problems can be multiplied when people are away from their home or business at the hours of dusk and dawn, for travel, or are otherwise occupied during the holiday season. Consequently, people desire a device that will automatically activate and deactivate seasonal holiday lights in response to changes in the level of light.

Therefore, there exists a long-felt need in the art for an improved extension cord device that eliminates the need to manually plug in and unplug electrical devices to turn on and turn off lighting at dusk and dawn. Additionally, there is a long-felt need in the art for an extension cord device that can detect light levels. Moreover, there is a long-felt need in the art for an electricity supply device that can activate and deactivate electrical devices as a function of light levels. Further, there is a long-felt need in the art for an extension cord device that can conserve energy usage and thereby lower energy costs.

The subject matter disclosed and claimed herein, in one embodiment thereof, comprises a multipurpose extension cord device. The extension cord device is designed to automatically activate connected electrical devices at dusk and automatically deactivate the electrical devices at dawn. The extension cord device has a power receiving plug for receiving electrical power from a standard electrical outlet, and at least one grounded electrical outlet for establishing an electrical connection with electric devices. A control housing in the device has a microprocessor, a power cut-off module, and at least one light sensor. The microprocessor is configured to detect a change in the light level resulting from solar events such as dusk and dawn. The microprocessor is also configured to enable and disable electrical power to the one or more grounded electrical outlets by actuating the power cut-off module based on the detection of a change in the level of environmental light.

In this manner, the extension cord device of the present invention accomplishes the forgoing objectives and provides users with a novel extension cord device that eliminates the need for users to plug in and unplug the extension cord to turn on electrical devices and turn off electrical devices, respectively. The extension cord device of the present invention detects changes in lighting and automatically activates or deactivates connected devices. The extension cord device of the present invention provides for electric power when needed or desired, conserves energy and reduces energy costs.

### SUMMARY OF THE INVENTION

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a light actuated extension cord device. The extension cord device can be configured to automatically activate or deactivate the supply of electrical power to connected electronic devices as a function of changes in lighting conditions. The extension cord device is comprised of a first end and a second end, the first end having an electrical power receiving plug configured to plug into a standard building electric outlet, the second end having a grounded electrical outlet enabling electrical connections with electronic devices such as lights; a control housing configured to house at least one light sensor, a microprocessor, and a power cut off module; the extension cord passing through the control housing. The microprocessor is configured to receive a signal from the at least one light sensor, the microprocessor is further configured to actuate the power cut off module to disable or enable power supply to the grounded outlet on determination of a change in light level associated with dusk and dawn, respectively. The enabling and disabling of the power supply to the grounded outlet is automatically performed by the device and does not require manual intervention by a user.

In yet another embodiment, the control housing has a memory for storing one or more ambient light threshold values that are used by the microprocess for comparison with the received ambient light levels measured by the one or more light sensors for determining a change in light level. The change in light level may be associated with dusk or dawn.

In yet another embodiment, the control housing includes an AC/DC converter, a DC/DC converter and one or more capacitors for providing an appropriate electrical power source to the electronic devices connected to the at least one electrical output of the device.

In yet another embodiment, the connected electrical devices may be external lights that include one or more lights from the list of lights that includes: Christmas lights, porch lights, patio lights, LED lights, High-Intensity Discharge lamps and more.

In yet another embodiment of the present invention, an electricity supply device with integrated dusk to dawn sensor is disclosed. The electricity supply device is in the form of an extension cord and is comprised of a power receiving plug for plugging into a standard building electrical outlet, a plurality of power outlets for establishing electrical connection with a plurality of electrical devices such as lights, a control housing for controlling the supply of electrical power to said plurality of power outlets, one or more light sensors supplying a microprocessor with light levels, the microprocessor configured to detect a change in light that may be associated with dusk or dawn, wherein the microprocessor disables or enables the power supply to at least one power outlet of the plurality of power outlets. The housing further comprises a separate control button for each power outlet of the plurality of power outlets and is configured to independently enable and disable each corresponding power outlet of the plurality of power outlets.

In yet another embodiment, when operating in a dusk to dawn configuration, the control housing has a memory that stores a turn ON-threshold and a turn OFF-threshold wherein the power is supplied to the power outlet for turning the connected electric device ON when the level of detected ambient light falls below the turn ON-threshold and power supply to the outlets is disabled for the connected lights when the level of ambient light exceeds a turn OFF-threshold.

Similarly, in another embodiment when the device is operating in a dawn to dusk configuration the control housing has a memory that stores a turn OFF-threshold and a turn ON-threshold wherein the power is supplied to the power outlet for turning the connected electric device, such as lights, OFF when the level of detected ambient light falls below the turn OFF-threshold and power supply to the outlets is enabled for the connected lights when the level of ambient light exceeds a turn ON-threshold. In either of said embodiments, the turn ON-threshold and the turn OFF-threshold have the same value or have different values. The light sensor further has a display for displaying the threshold value or values.

A further embodiment discloses a method for automatically activating and deactivating electronic devices connected to an extension cord device is described. The method includes the steps of detecting light using at least one light sensor. A microprocessor compares the light levels of the at least one light sensor with preconfigured threshold values stored in the microprocessor and determines if a change in light event, such as dusk or dawn, has occurred. Based on the determination of the microprocessor, the microprocessor may enable or disable the power supply to the outlet to which the lights are connected to activate or deactivate the lights automatically, based on changes in the ambient environmental light. Additional embodiments of the method involve automatically activating and deactivating electronic devices to allow the user to input and adjust the threshold values in a memory unit used by the microprocessor.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view showing the components of one potential embodiment of the extension cord device of the present invention in accordance with the disclosed architecture;

FIG. 2 illustrates a perspective view showing Christmas lighting attached to one potential embodiment of the extension cord device of the present invention in accordance with the disclosed architecture;

FIG. 3 illustrates a perspective view of one potential embodiment of the extension cord device of the present invention in which the extension cord has multiple electrical outlets in accordance with the disclosed architecture;

FIG. 4 illustrates an internal view of the control housing of one potential embodiment of the extension cord device of the present invention in accordance with the disclosed architecture; and

FIG. 5 illustrates a flow diagram showing exemplary steps performed in operation of one potential embodiment of the extension cord device of the present invention to automatically disable electricity supply in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved extension cord device that is capable of automatically activating and deactivating electrical devices, such as decorative seasonal lights. There is also a long-felt need in the art for a device that eliminates the need to manually plug in and unplug lights at certain times of day. Additionally, there is a long-felt need in the art for a device that can activate connected electrical devices, such as lights, at night and deactivate the devices during day. Moreover, there is a long-felt need in the art for an electricity supply device that eliminates the need to remember to plug in an electrical device at dusk and unplug the electrical device at dawn. Further, there is a long-felt need in the art for an extension cord device that can be used for a variety of applications, both indoor and outdoor. Finally, there is a long-felt need in the art for an extension cord device that can determine the time of day to automatically disable and enable electrical power to connected electrical devices such as lights.

The present invention, in one exemplary embodiment, is a light actuated extension cord device. The extension cord device is in the form of an extension cord and is comprised of a power outlet for establishing electrical connection with an electrical device, a power receiving plug for plugging into a standard building electrical wall outlet, a control housing for controlling the supply of power to the power outlet plug, at least one light sensor for detecting environmental light levels for determining a change in light associated with dusk and dawn wherein a microprocessor disables the power supply to the power supply outlets when a dawn solar event is detected and enables the power supply to the power supply outlets when a dusk solar event is detected. The housing further has a control button for the power outlet configured for enabling and disabling the power outlet.

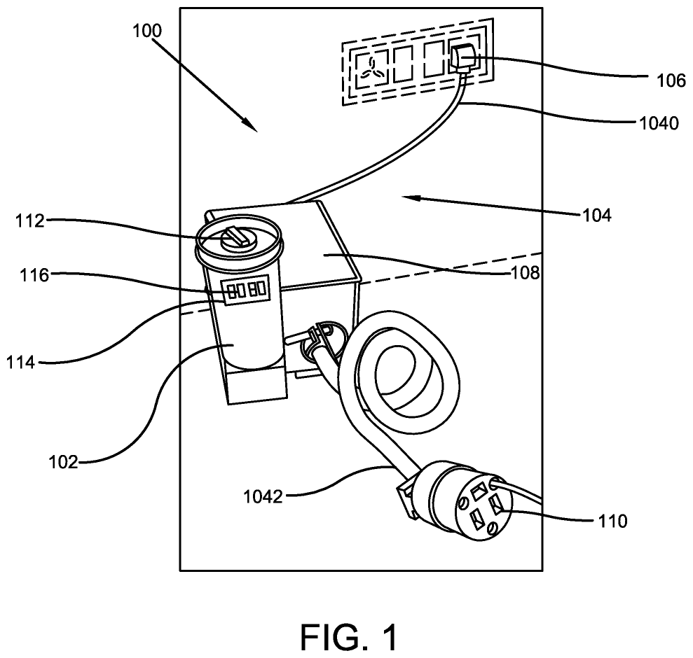

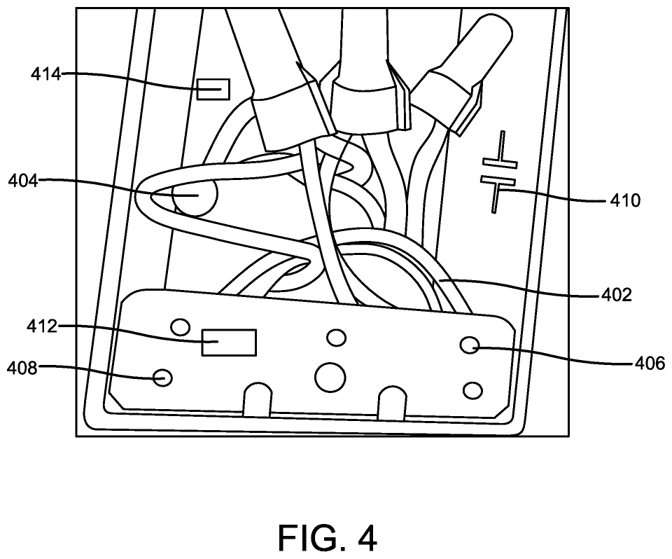

Referring initially to the drawings, FIG. 1 illustrates a perspective view of one potential embodiment of the extension cord device 100 of the present invention in accordance with the disclosed architecture. The extension cord device 100 of the present invention is designed as an extension cord of any length, but is preferably of a length of up to five feet with an integrated light sensor 102. The cord 104 has a first end 1040 and a power receiving supply plug 106 is disposed on the first end 1040. The power receiving supply plug 106 is configured to plug into an electric supply such as a conventional electric power supply socket operating in the range of between 60 Hz and 100 Hz. The device 100 has a control housing 108 configured to house the circuit connections of the extension cord 104. The light sensor 102 is detachably attached to the housing 108 and the housing 108 further has an power cut off module as best shown in FIG.4. The device has a second end 1042 of the extension cord 104 having a grounded power outlet plug 110 that allows an electric device, such as but not limited to: Christmas lights, porch lights, patio lights, or any other electric device to connect to the extension cord device 100. The grounded power outlet plug 110 is configured to receive any standard electrical device.

The extension cord device 100 is ideal for outdoor use. The cord 104 is preferably made from durable, heavy-duty, weatherproof, and fireproof poly(phenyl ether) (PPE) material. Further, the extension cord device 100 can preferably withstand temperatures from −30° F. to 150° F.

The light sensor 102 is preferably a photocell sensor that is configured to detect ambient environmental light. The extension cord device 100 automatically provides electrical power to the outlet 110 when no or low light is detected by the sensor 102. More specifically, the extension cord device 100 is configured to use light level changes to detect one or more solar events such as, but not limited to, dusk and dawn. For example, when sufficient ambient light is detected by the sensor 102 to indicate the presence of daylight, the device does not allow electrical power to be supplied to the outlet 110 and accordingly, the electrical devices connected to the outlet 110 are turned off. More specifically, the extension cord device 100 has an ON-threshold and an OFF-threshold. The extension cord device 100 turns the connected devices ON when a level of light or illumination in an environment falls below the turn ON-threshold and turns the connected light sources OFF when the level of light or illumination exceeds an OFF-threshold.

In the present embodiment, the device 100 can have a rotating knob 112 to configure the level of environmental light required to meet and/or exceed the ON-threshold and OFF-threshold. The device 100 has a display 114 displaying the ambient light value 116 that is set as an ON-threshold and an OFF-threshold, thereby enabling a user to review the threshold values for automatically activating and deactivating electrical power to the grounded power outlet plug 110. The ON-threshold and the OFF-threshold are ideally the same in the present embodiment, but the value of the OFF-threshold may be configured to be slightly more than the ON-threshold to account for the hysteresis of the sensor 102 and other circuitry housed within the control housing 108 (described in FIG.4).

The control housing 108 is positioned at a position along the length of the cord 104 such that the housing 108 partitions the cord 104 into two lengths with the first end 1040 positioned on one side of the housing 108 and the second end 1042 positioned on the opposite side of the housing 108. This enables the device 100, when the sensor 102 detects environmental light exceeding a turn OFF threshold, to stop the flow of electrical current at a point between the power plug 106 where electrical power enters the device and the power outlet 110 where electrical power leaves the device.

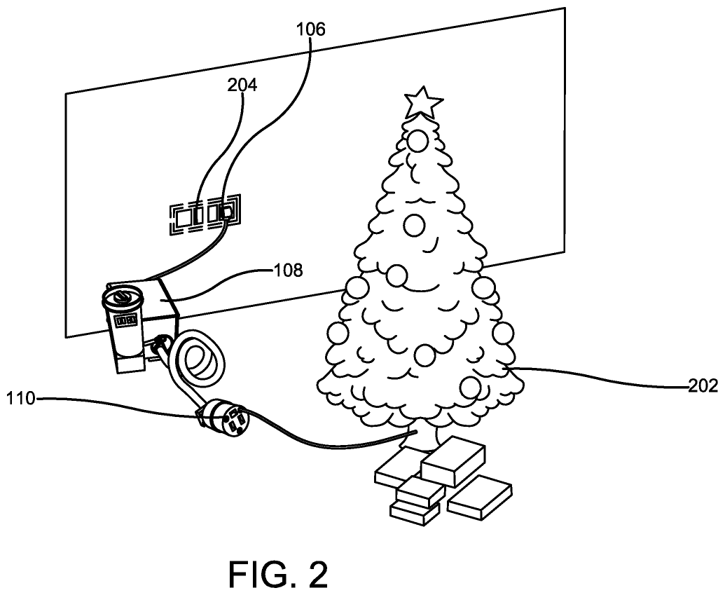

FIG. 2 illustrates a perspective view showing Christmas lighting 202 attached to one potential embodiment of the extension cord device 100 of the present invention in accordance with the disclosed architecture. As shown, in the present embodiment, the device 100 is used for illuminating Christmas lights 202, wherein the Christmas lights 202 are connected to the grounded outlet 110 and the power supply plug 106 is plugged into a standard electric supply 204. The light sensor 102 attached to the control housing 108 monitors the ambient environmental light and a microprocessor in the housing 108 automatically activates the Christmas light 202 when the ambient light is lower than the turn ON threshold. The microprocessor 414 in the housing 108 automatically deactivates the Christmas light 202 when the ambient light is greater than the OFF threshold. Accordingly, the extension cord device 100 eliminates the need to manually plug in and unplug the Christmas lights 202 from the extension cord or the power supply.

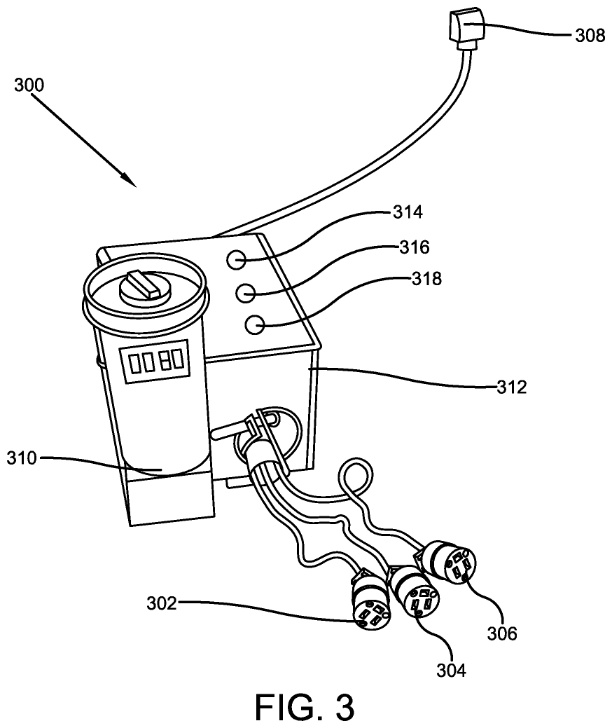

FIG. 3 illustrates a perspective view of one potential embodiment of the extension cord device 100 of the present invention in which the extension cord has multiple electrical outlets in accordance with the disclosed architecture. In this embodiment, the electricity supply device 300 has a plurality of grounded power outlets 302,304,306 allowing a plurality of lights or other appliances to connect to the electricity supply device. The electricity supply device 300 has a single power receiving end 308 that can be plugged into a standard power supply outlet and can provide power to the plurality of grounded power outlets 302,304,306.

The electricity supply device 300 has at least one light sensor 310 configured to measure environmental light allowing the electricity supply device 300 to maintain or interrupt electrical power supply between the plug 308 and the power outlets 302,304,306. The control housing 312 has the circuitry to allow the flow of electrical power to the power outlets 302,304,306 when the ambient or environmental light sensed by the sensor 310 is below an ON threshold wherein the ON threshold can have a value of 10 lux. The control housing 312 also has the circuitry to interrupt the flow of electrical power to the outlets when the ambient or environmental light sensed by the sensor 310 is above an OFF threshold.

The device 100, 300 can also be configured to operate in a dawn to dusk configuration. In this configuration the device 100, 300 allows the flow of electrical power when the sensor 310 detects ambient or environmental light levels above an ON-threshold and interrupts the flow of electricity when the measured environmental light level falls below the OFF-threshold.

The one or more power outlets 302,304,306 can be selectively used by a user by connecting an individual power outlet to an external light or other electrical device. When one of the power outlets 302,304,306 is used for connection to an external light such as Christmas light, patio or porch light, then in this embodiment, the other power outlets 302,304,306 can be deactivated using the corresponding control buttons positioned on the housing 312.

Each power outlet 302,304,306 has a corresponding control button 314,316,318 positioned on the housing 312 such that each outlet 302,304,306 can be selectively enabled or disabled using the corresponding control button. The extension cord device 300 is configured to uniformly provide electric power to the grounded outlets 302,304,306.

FIG. 4 illustrates an internal view of the control housing 108 of one potential embodiment of the extension cord device 100 of the present invention in accordance with the disclosed architecture. The control housing 108 in the present embodiment is described with reference to the housing 108 of the device 100, but internal details are applicable to the control housing of other embodiments of the present invention. As shown, the housing 108 has wiring 402 connecting the power receiving supply plug (not shown) and grounded power outlet (not shown) of the device 100. Further, the housing 108 has a power cut-off module 404 that is configured to cut-off or interrupt the flow of electrical power through the wiring 402, thereby preventing the flow of electricity to the power outlet. The power cut-off module 404 is coupled to a microprocessor 414.

The extension cord device 100,300 can be operated in a dusk to dawn or a dawn to dusk configuration, allowing power to be supplied to connected devices during the night or daylight respectively. In the dusk to dawn configuration, when the microprocessor 414 receives a light level from the light sensor 102 that is above a preconfigured OFF threshold, the microprocessor 414 actuates the cut off module 404 to cut off or interrupt the supply of electric power through the wiring 402. In the dawn to dusk configuration, when the microprocessor 414 receives a light level from the light sensor 102 that is above the ON threshold, then the cut off module 404 is actuated to close the circuit, or turn on the supply of electric power through the wiring 402.

The power cut-off module 404 can be a capacitor-based circuit module and is configured to receive a control signal from the microprocessor 414. The housing 108 is made from an insulating and weatherproof material that protects the circuit 402 and the module 404 from inclement weather. In other embodiments, the housing may also have circuits connecting control buttons disposed on the housing with the grounded outlets; thereby allowing for selectively disabling or enabling each grounded outlet.

The control housing of various embodiments of the present invention can also have an AC/DC converter 406, DC/DC converter 408 and capacitors 410 for providing an appropriate source of power to the connected electrical devices. This is especially applicable to Christmas, porch and patio lights. The control housing may receive an AC power signal from the power supply plug, generate a DC power output and supply the generated DC power output to the light sources connected to the outlets.

A memory 412 disposed within the control housing 108 is used for storing threshold light values used by the microprocessor 414 for comparing the measured light values with threshold values. The microprocessor 414 can actuate the power cut-off module 404 to disable and enable electricity supply to the outlets. The microprocessor 414 can be any logic processing unit such as microprocessors, digital signal processors (DSPs), application-specific integrated circuits (ASICs), field programmable gate arrays (FPGAs) or similar functioning devices.

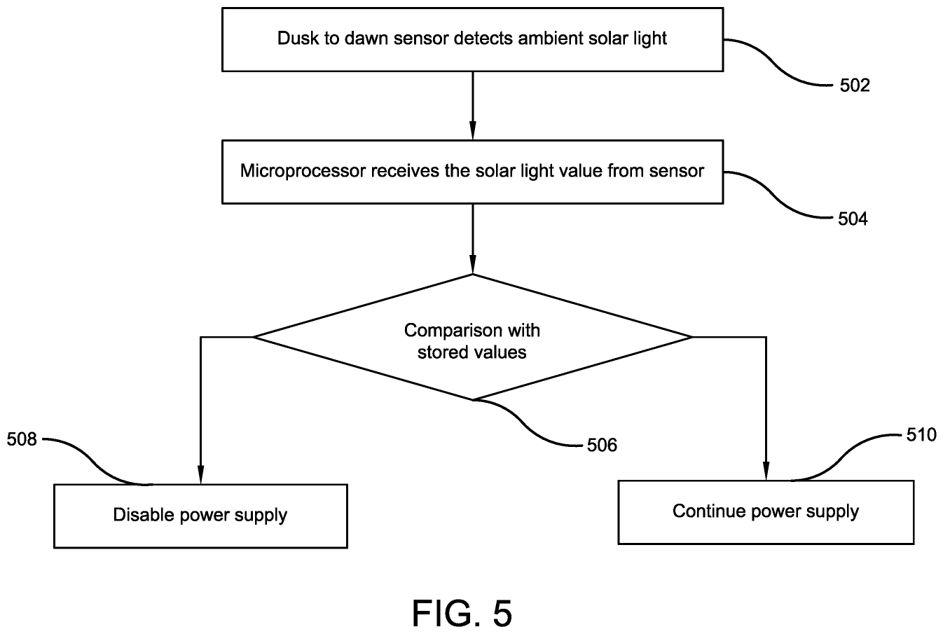

FIG. 5 illustrates a flow diagram showing exemplary steps performed in operation of one potential embodiment of the extension cord device 100 of the present invention configured for dusk to dawn operation, to automatically disable the electricity supply in accordance with the disclosed architecture. As shown, initially the ambient solar light is detected by the light sensor 102 of the device (Step 502). Then, the microprocessor 414 of the device receives the detected value of environmental light from the light sensor 102 (Step 504). Thereafter, the microprocessor 414 compares the received value with the threshold values stored in the memory 412 (Step 506) to determine if the detected value is more than an OFF-threshold value, then the microprocessor 414 interprets the situation as dawn and the power supply to the outlets is disabled by the cut off module to deactivate the connected lights (Step 508). Otherwise, the process moves to the Step 510, and the electricity is continued to be supplied to the outlets for providing power to the connected external light sources.

Alternatively, if operating in the dawn to dusk configuration the microprocessor 414 compares the measured light level with the threshold values stored in the memory (Step 506) to determine if the detected value is less than an OFF-threshold value and/or more than an ON-threshold value. If the measured light level is less than an OFF-threshold value, then the microprocessor interprets the situation as dusk and the power supply to the outlets is disabled. If the measured light level is more than an ON-threshold value, the microprocessor interprets the situation as day or dawn and the electrical power to the connected electrical devices is enabled.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dawn to dusk extension cord device”, “dusk to dawn extension cord device”, “extension cord device”, “device”, “extension cord”, “light actuated extension cord”, and “electricity supply device”, are interchangeable and refer to the extension cord device 100,300 of the present invention.

Notwithstanding the forgoing, the extension cord device 100,300 of the present invention can be of any suitable size and configuration as is known in the art without affecting the overall concept of the invention, provided it accomplishes the above-stated objectives. One of ordinary skill in the art will appreciate that the size, configuration and material of the extension cord device 100,300 as shown in the FIGS. are for illustrative purposes only, and that many other sizes and shapes of the extension cord device 100,300 are well within the scope of the present disclosure. Although the dimensions of the extension cord device 100,300 are important design parameters for user convenience, the extension cord device 100,300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A light actuated extension cord device comprising:
an extension cord having a first end and a second end, wherein the first end is comprised of a power receiving plug configured to insert into a standard electrical power supply, and further wherein the second end comprises a power outlet plug configured to receive an electrical device; and
a control housing comprised of at least one light sensor, a microprocessor and an electric power cut-off module, wherein the control housing is located between the first end and the second end of the extension cord and is configured to automatically enable and disable a flow of electrical power through the extension cord.

2. The light actuated extension cord device of claim 1, wherein the control housing further comprises a memory of stored threshold light values.

3. The light actuated extension cord device of claim 2, wherein the control housing further comprises a rotating knob that can be used to adjust the stored threshold light values in the memory.

4. The light actuated extension cord device of claim 3, wherein the microprocessor is configured to receive a measured light level from the at least one light sensor, compare the measured light level and the stored threshold light values in the memory, and actuate the electric power cut-off module based on the compared measured light level and the stored threshold light values.

5. The light actuated extension cord device of claim 1, wherein the control housing is comprised of a display for illustrating a light level measured by the at least one light sensor.

6. The light actuated extension cord device of claim 1, wherein the control housing is comprised of an alternating current to direct current converter.

7. The light actuated extension cord device of claim 1, wherein the extension cord is manufactured from a weatherproof and fireproof material.

8. The light actuated extension cord device of claim 1, wherein the extension cord is comprised of a poly(phenyl ether).

9. An electricity supply device comprising:
an extension cord having a power receiving end with a power supply plug that is sized and configured to be inserted into a standard electrical power supply;
a plurality of power outlets each having an outlet plug that is sized and configured to receive an electrical device; and
a control housing comprised of at least one light sensor, a microprocessor and an electric power cut-off module, wherein the control housing is located between the power receiving end and the plurality of power outlets and is configured to automatically enable and disable a flow of electrical power through each of the plurality of power outlets.

10. The electricity supply device of claim 9, wherein the control housing is further comprised of a memory of stored threshold light values for each of the plurality of power outlets.

11. The electricity supply device of claim 10, wherein the control housing is further comprised of a rotating knob for each of the plurality of power outlets that can be used to adjust the stored threshold light values for each of the plurality of power outlets.

12. The electricity supply device of claim 11, wherein the microprocessor is configured to receive a measured light level from the at least one light sensor and compare the measured light level with the stored threshold light value for each of the plurality of power outlets, and thereby actuate the electric power cut-off module.

13. The electricity supply device of claim 9, wherein the control housing is further comprised of a display.

14. The electricity supply device of claim 9, wherein the control housing is further comprised of an alternating current to direct current converter.

15. The electricity supply device of claim 9, wherein the extension cord is comprised of a weatherproof and fireproof material.

16. A method of automatically activating and deactivating electrical devices comprising:
obtaining measured environmental light levels;
obtaining a comparison of stored threshold light values and the measured environmental light levels; and
closing or opening an electric circuit based on the comparison of the stored threshold light values and the measured light levels.

17. The method of automatically activating and deactivating electrical devices of claim 16, wherein a user can input the stored threshold light values.

18. The method of automatically activating and deactivating electrical devices of claim 16, wherein the measured environmental light levels are obtained with a light sensor.

19. The method of automatically activating and deactivating electrical devices of claim 16, wherein the comparison of the stored threshold light values and the measured environmental light levels is obtained with a microprocessor.

20. The method of automatically activating and deactivating electrical devices of claim 16, wherein the closing or opening an electric circuit based on the comparison of the stored threshold light values and the measured light levels is performed with an electric power cut-off module.
